(19) United States
(12) Patent Application Publication
(10) Pub. No.: US 2025/0184671 A1
(43) Pub. Date: Jun. 5, 2025

(54) ACOUSTIC PATH ANOMALY DETECTION FOR OTOSCOPIC ASSESSMENT

(71) Applicant: Starkey Laboratories, Inc., Eden Prairie, MN (US)

(72) Inventors: Piero Iared Rivera Benois, Bad Zwischenahn (DE); Henning Schepker, Oldenburg (DE); Xianhua Jiang, Eden Prairie, MN (US)

(21) Appl. No.: 18/953,760

(22) Filed: Nov. 20, 2024

Related U.S. Application Data
(60) Provisional application No. 63/604,366, filed on Nov. 30, 2023.

(51) Int. Cl. H04R 25/00

(52) U.S. Cl. CPC H04R 25/305; H04R 25/558; H04R 25/70

(57) ABSTRACT

A self-check is initiated via an audio processor circuit of a hearing device while located in a user's ear. In response to the self-check, the device measures a first transfer function of a first feedback path between a receiver of the hearing device and at least one outward facing microphone of the hearing device, and measures a second transfer function of a second feedback path between the receiver and an inward facing microphone of the hearing device, An anomaly is determined in at least one of the first transfer function and the second transfer function, and an otoscopic condition of the ear is detected based on the anomaly.

### RELATED PATENT DOCUMENTS

This application claims the benefit of U.S. Provisional Application No. 63/604,366, filed on Nov. 30, 2023, which is incorporated herein by reference in its entirety.

### SUMMARY

This application relates generally to ear-level electronic systems and devices, including hearing aids, personal amplification devices, and hearables. In one embodiment, a self-check is initiated via an audio processor circuit of a hearing device while the device is located in an ear of a user. A first transfer function is measured of a first feedback path between a receiver of the hearing device and at least one outward facing microphone of the hearing device. A second transfer function is measured of a second feedback path between the receiver and an inward facing microphone of the hearing device. Via a sound processor circuit, an anomaly is determined in at least one of the first transfer function and the second transfer function. An otoscopic condition of the ear is predicted based on the anomaly and an indication of the otoscopic condition is presented via a user interface circuit.

The figures and the detailed description below more particularly exemplify illustrative embodiments.

### BRIEF DESCRIPTION OF THE DRAWINGS

The discussion below makes reference to the following figures.

FIG. 1 is an illustration of a hearing device in an ear according to an example embodiment;

FIG. 2 is a block diagram showing feedback cancellation characterization data being collected according to an example embodiment;

FIG. 3 is block diagrams showing functional blocks of a hearing device according to an example embodiment;

FIG. 4 is a flow diagram showing operation of a feedback cancellation characterization procedure according to an example embodiment;

FIG. 5A is a block diagram of a decision tree for anomaly detection and classification according to an example embodiment;

FIGS. 5B and 5C are diagrams showing an implementation of classifiers used in a decision tree according to example embodiments;

FIG. 6 is a table showing a mapping between classes used by the classifiers and the state of the two microphones and the receiver used in determining abnormalities/faults in a device according to an example embodiment;

FIGS. 7 and 8 are flowcharts of methods according to example embodiments;

FIG. 9 is a block diagram of a hearing device and system according to an example embodiment;

FIG. 10 is a block diagram of a system according to an example embodiment;

and

FIG. 11 is a flowchart of an otoscopic detection method according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to herein as “hearing aids,” “hearing devices,” and “ear-wearable devices”), such as hearables (e.g., wearable earphones, ear monitors, and earbuds), hearing aids, hearing instruments, and hearing assistance devices, typically include an enclosure, such as a housing or shell, within which internal components are disposed.

Embodiments described herein relate to detecting anomalies in an ear-wearable device. For example, acoustic-related anomalies in a hearing device and/or an ear of the patient can be determined during a fitting process initiated by the clinician. In other cases, the anomalies can be found during a diagnostic routine initiated by the patient, when the device is placed inside a charger and the lid is closed, and other situations when the device is out-of-ear. In one embodiment, a data-driven approach optimizes a model using examples of devices and ears presenting different types of acoustic-related anomalies. For example, a mathematical combination of a receiver-to-microphone transfer functions measured during the fitting process (or diagnostic routine) are analyzed via an algorithm. The algorithm can output a specific diagnostic message, for instance, an alphanumeric code, a text or audible message such as “All microphones and receiver of the hearing device are clean. Patient might be suffering of an otitis externa.”

The acoustic-related issues detected using this process may include device anomalies, such as abnormal behavior of the outward-facing and/or inward-facing microphones, receiver and combined problems thereof, as well. In other embodiments, the acoustic-related issues may also relate to debris blocking audio paths to microphones and receivers, such as dust, liquids, earwax, etc. This may also include the material within the ear canal, such as a buildup of earwax. In other embodiments, the same technique can detect acoustic-related indicative of ear canal and eardrum pathologies, e.g., that may be apparent once proper device performance is confirmed.

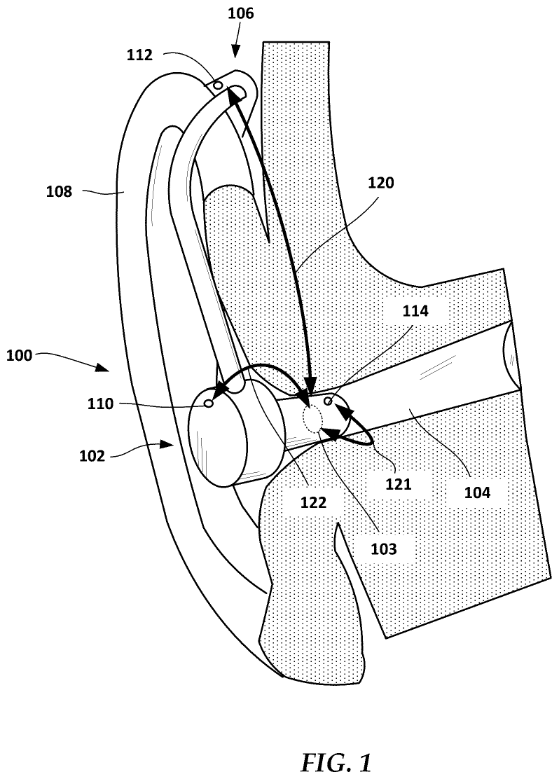

In FIG. 1, a diagram illustrates an example of an ear-wearable device 100 according to an example embodiment. The ear-wearable device 100 includes an in-ear portion 102 that fits into the ear canal 104 of a user/wearer. The ear-wearable device 100 may also include an external portion 106, e.g., worn over the back of the outer ear 108. The external portion 106 is electrically and/or acoustically coupled to the internal portion 102. The in-ear portion 102 may include an acoustic transducer 103, although in some embodiments the acoustic transducer may be in the external portion 106, where it is acoustically coupled to the ear canal 104, e.g., via a tube. The acoustic transducer 103 may be referred to herein as a “receiver,” “loudspeaker,” etc., however could include a bone conduction transducer. One or both portions 102, 106 may include an external microphone, as indicated by respective microphones 110, 112. If the device has an external portion 106, it may have two microphones 112 (e.g., front and rear microphones). Each of the microphones 110, 112 may be referred to interchangeably as an external microphone, an outward-facing microphone, or an environmental microphone. External or outward-facing microphones may be positioned or otherwise configured to detect sounds outside of the ear canal 104 such as, for example, sounds from an environment of the user/wearer or sounds from the receiver 103 that travel outside of the ear canal 104.

The device 100 may also include an internal microphone 114 that detects sound inside the ear canal 104. The internal microphone 114 may also be referred to as an inward-facing microphone or error microphone. Other components of hearing device 100 not shown in the figure may include a processor (e.g., a digital signal processor or DSP), memory circuitry, power management and charging circuitry, one or more communication devices (e.g., one or more radios, a near-field magnetic induction (NFMI) device), one or more antennas, buttons and/or switches, for example. The hearing device 100 can incorporate a long-range communication device, such as a Bluetooth® transceiver or other type of radio frequency (RF) transceiver.

While FIG. 1 shows one example of a hearing device, often referred to as a hearing aid (HA), the term hearing device of the present disclosure may refer to a wide variety of ear-level electronic devices that can aid a person with or without impaired hearing. This includes devices that can produce processed sound for persons with normal hearing, such as noise addition/cancellation to treat misophonia. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a system comprising a single left ear device, a single right ear device, or a combination of a left ear device and a right ear device.

Acoustic feedback occurs due to the acoustic coupling of the hearing aid receiver 103 and at least one of the microphones 110, 112, 114, creating a closed loop system. The term feedback is often associated with an instability once the feedback reaches a threshold level, however feedback also exists in a stable system. A feedback path is an acoustic coupling path between receiver and microphones. Examples of feedback paths 120, 121, 122 are indicated by bold lines in the figure. Note that feedback can occur between any microphone 110, 112, 114 and the receiver 103, and the use of only one of the reference numbers 110, 112, 114 in subsequent diagrams is not meant to limit the embodiments to only one of the illustrated microphones. Also note that path 121 is sometimes referred to as a secondary path, as the internal microphone 114 is not typically used in feedback cancelling. Nonetheless, the term “feedback path” as used herein covers any microphone to receiver acoustic path whether or not it is used for feedback cancellation or other feedback processing.

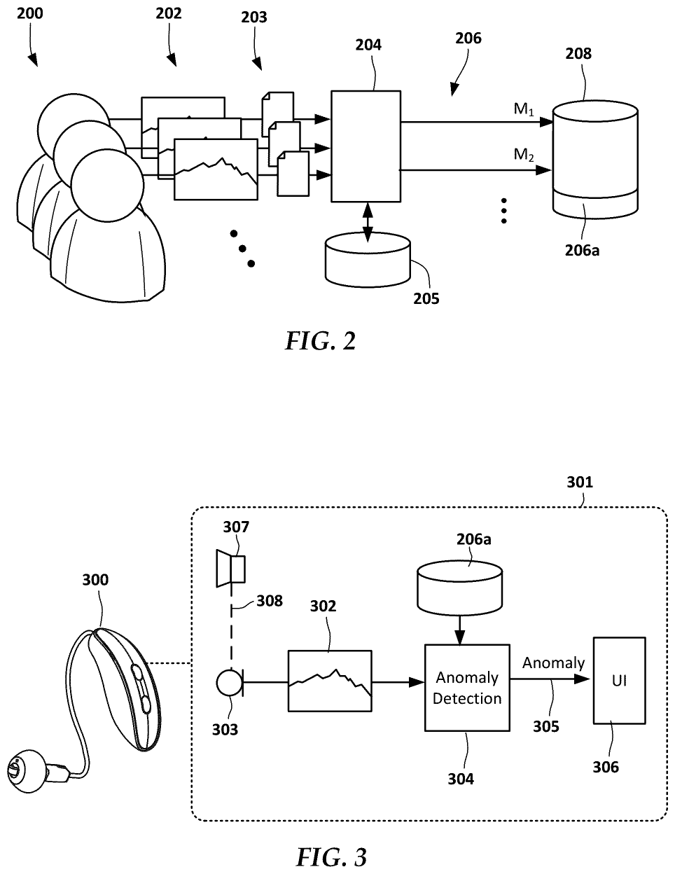

In FIG. 2, a block diagram shows feedback path characterization data being compiled according to an example embodiment. A population 200 of test subjects is tested with hearing devices to determine an associated set of feedback path responses 202 and supplementary data 203. The other supplementary data 203 may include other measurements (e.g., responses to external test signals), test subject characteristics (e.g., age, sex, etc.), otoscopic data (e.g., pathologies, ear geometry, etc.), device characteristics (e.g., device type, model number, etc.), and any naturally occurring or simulated anomalies (e.g., device abnormality or fault, otoscopic pathologies, earwax or other blockage, etc.). The data 202, 203 are input to an analyzer 204 which outputs various models 206. The data 202, 203 may also be stored in a data storage medium 205 in original and/or reduced forms.

The models 206 may include a simplified set of data that allows characterizing an arbitrary feedback path response (e.g., measured via a self-check by audio processor circuit of a hearing device) as normal or abnormal. In this context, “normal” does not necessarily indicate there that the hearing device is optimal installed or configured. Generally, a “normal” characterization indicates that tested-for anomalies are not detected within some level of confidence. For example, if an in-ear part the hearing device is not optimally sealed in the ear canal, this may still be considered as normal operation if no other discrepancies in the feedback path response are found. In other cases, if poor fitting is a tested for condition, this may be considered abnormal if the effect on performance (e.g., a deviation of the transfer function from what is expected) is significant enough to be detected.

While FIG. 2 shows the use of human test subjects, other data can be collected by the devices themselves. For example, device responses can be measured while the device is on a table, in a charging stand, or in some other out-of-ear configuration. These data sets can be collected under normal and abnormal conditions. Also, some characterization data of the models 206 may be created using mathematical models in order to simulate some known conditions that affect feedback path responses.

To aid in the creation of the models 206 in one embodiment, particular path responses 202 are sorted into categories that describe certain anomalies, or lack thereof. The supplementary data 203 can include labels for those categories. For example, a set of responses may be labeled with “front microphone blocked” based on microphone being intentionally or unintentionally blocked when the measurement of feedback path responses 202 were made. Similar labels can be used for other device-fault anomalies as described herein, as well as otoscopic pathologies, such as blocked ear canal due to swelling or earwax, perforated ear drum, etc. These anomalies can be characterized across a large diversity of test subjects and hearing devices enabling the models 206 can detect these anomalies over a wide range of devices and users. Note that issues associated with a hearing device may not be an actual device fault but may result from improper use, and so the term “abnormality” is used here to cover faults, failures, misbehaviors, misconfigurations, etc. within the device itself as well as external uses or events that are considered detrimental to operation of the hearing device. Also, where the term “fault” is used hereinbelow in reference to detecting device faults, it is understood to also cover device abnormalities unless otherwise indicated.

Another type of supplementary data 203 that may be used to form the models 206 are characterizations of the test subjects and the hearing devices used in the tests. For example, certain characteristics of the test subjects such as age and gender may be exhibit trends in the feedback path responses 202, such that different models 206 may be applied depending on whether the user is above or below a given age and or belongs to a specific gender. Another characterization that may be recorded in the supplementary data 203 relates to the type of devices used in the testing. This may refer to a class of device (e.g., in the ear, receiver in canal, etc.), a manufacturer model number of the device, etc. The building of different models 206 for different devices may be useful such as where the number of microphones and location of microphones relative to the receiver are similar within each class even if the devices in the class are not the same model number. Other types of supplementary data may include scans of ear impressions (e.g., that define a geometry of the ear canal or other structures), ear size (e.g., indirectly inferred from cable length or pictures of the ear), and health of the eardrum.

The analyzer 204 may use a number of techniques to build the models 206 based on the data 202, 203. Statistical techniques such as averaging feedback path frequency responses for segments of the population 200 may reveal some trends. Averaging may be performed within groups of similar user classes, device classes, and anomaly types. Another technique that may be used is the use of a feedforward, deep, neural network as a classifier.

In a neural network embodiment, the feedback path responses 202 can be encoded and input to an input layer of a neural network. For example, the feedback path responses 202 can be divided into frequency ranges that span at least part of the audible spectrum, and a representative value (e.g., dB of gain) at each frequency range (or center frequency of the range) can be the input for each input node. The supplementary data 203 can be used as labels for the classification, and assuming the set of data 202, 203 is large enough, it can be divided into training, validation, and test data sets to train the model 206 and validate the results.

In Table 1 below, details are shown of a neural network that may be used as anomaly detection/classification models 206. The output of the network may be an anomalous/non-anomalous indication and/or a classification of anomalies. The network may be configured as a feedforward neural network with a convolutional neural network (CNN) layer for integrating the impulse responses into the input to a fully connected layer together with the frequency response and movement and orientation vectors. The inputs are digitized and encoded into a format suited for a neural network, e.g., frequency-domain feedback path responses and time-domain movement and orientation data.

TABLE 1

| Neural Network Property | Description |
|---|---|
| Network Topology and Use | Impulse response → CNN → Dropout→ |
| of Recurrent Units | (integrate below) |
| | Frequency responses → (integrate below) |
| | Movement and orientation vectors → |
| | (integrate the upper branches) → Fully |
| | Connected → Output. |
| Data format for inputs | Impulse response, magnitude and phase |
| | frequency responses of the feedback paths |
| | (receiver to microphones acoustic transfer |
| | function), and orientation (time-smoothed |
| | x-y-z orientation vector) and movement |
| | (time-smoothed combined-variance of x-y-z |
| | accelerometer signals) information |
| | extracted from IMU signals. |
| Propagation function | Multiplication and addition of weights |
| Transfer/Activation | Sigmoid activation function |
| function: | |
| The learning paradigm | Supervised learning for classification |
| Training dataset | Multiple thousands of feedback path |
| | examples (80% train-10% test-10% test). |
| | Balanced or unbalanced training set |
| | considering combinations of all targeted |
| | issues, receiver gains, earbud designs and |
| | hearing device design variants that were |
| | measured using a demographic-relevant |
| | group of human subjects. |
| Cost function | Weighted cross-entropy between predicted |
| | and true class |
| Starting values | Random values |

One feature of neural networks classifiers is that they can be configured to provide multiple classifications for the same input, e.g., provide a probability that the input belongs to each of the classes. To improve accuracy, different networks may be trained for different higher level classes of devices, users, or other characteristics (e.g., device in ear, device on table). For example, the data from hearing devices with inward-facing microphones may be used to train different networks than data from hearing devices without inward-facing microphones. A number of different networks can be formed in this way and selectively used in an operational device depending on the device type and the user of the device.

The models 206 are stored in a data storage media 208. The storage media 205, 208 may include a relational database, object-based storage, or other data storage system that allows linking together the originally collected data 202, the supplementary data 203, and the models 206 created using the collected and/or generated data (e.g., generated using mathematical models). The data storage medium 208 may store a large number of models 206, only a subset of which may be used in a given hearing device, referred to herein as deployable or deployed data 206a.

In FIG. 3, a block diagram shows the implementation of the feedback path characterization data in an operational hearing device 300 according to an example embodiment. Block 301 represents hardware, firmware, and software components operable on the hearing device 300. In this example, the feedback path characterization data is provided as the deployed data 206a the models described in FIG. 2. The deployed data 206a may be identified and stored on a storage medium of the hearing device 300 at manufacture, during fitting, and/or while in use, e.g., by the user via an application on a smartphone. An anomaly detection block 304 may also be provided in a similar manner as the deployed data 206a. In one embodiment, the anomaly detection block 304 is implemented on an audio processor circuit of the hearing device 300, e.g., digital signal processor (DSP) and associated software and firmware that controls the DSP hardware. In other embodiments, the anomaly detection block 304 can be implemented on an external device such as a mobile phone or a device used by a clinician. In the latter case, the functionality of the anomaly detection block 304 can be added to the fitting software that the clinician uses to fit the device 300 to the patient. Note that even in case where the detection is performed by a third party such a clinician, this can still be considered a “self-check,” in that the hearing device is being used to measure its own performance and also measure the surrounding environment that affects the feedback path.

Generally, the anomaly detection block 304 operates in response to a self-check that may be initialized by a practitioner, a user, and/or automatically (e.g., in the background when the device is either in use or not in used but powered on). In response to the self-check, the hearing device 300 measures a transfer function 302 of a feedback path 308 between a receiver 307 of the hearing device 300 to a microphone 303 of the hearing device 300. The anomaly detection block 304 determines an anomaly 305 in the transfer function 302 via comparison with example feedback path characterization data, in this case deployed data 206a.

In one or more embodiments, the anomaly 305 is predictive of a fault associated with the hearing device, e.g., a malfunction or blockage affecting the microphone 303 and/or receiver 307. In other embodiments, the anomaly is predictive of an otoscopic condition of the user's ear, e.g., perforated eardrum. The anomaly 305 may be predictive of other non-optimum operating conditions, such as poor or improper fitting, unsupported use conditions (e.g., worn while swimming) and the like. Examples of non-optimum conditions that may result in anomalies are shown in Table 2 below.

TABLE 2

| Anomaly Type | Anomaly | Issue/Abnormality |
|---|---|---|
| Hardware Issues | Mic/rcvr sensitivity variations | Humidity or temperature |
| | Mic/rcvr distortion | Dropped or magnetized |
| | Mic/rcvr noise floor increase | Humidity or temperature |
| | Mic/rcvr dynamic range loss | Combination of issues |
| | Low SPL level from receiver | Receiver, e.g., |
| | | mechanical failure, |
| | | debris |
| | Low SPL level from microphone | Microphone(s), e.g., |
| | | mechanical failure, |
| | | debris |
| Earwax on | Loss in gain in all feedback paths | Wax on receiver/bud |
| Device | during fitting | outlet |
| | Loss in gain in a particular subset of | Debris on microphone(s) |
| | feedback paths during fitting | |
| Wear | Feedback paths have a very high gain | Device not in the ear |
| | (during fitting) | |
| | Sudden change in feedback path gain | Device removed during |
| | during operation | operation |
| | IMU data shows a deviation in | Wrong wire-length |
| | orientation | |
| | spectral features of the feedback paths | Insufficient insertion |
| | present in different frequencies than | depth |
| | expected | |
| | Spectral features of the feedback paths | Device sliding out of the |
| | moving from higher to lower | ear |
| | frequencies | |
| | Acoustic leakage during fitting | Wrong bud-type, size |
| | | ripped bud |
| | Acoustic leakage during operation | Ripped bud, devices |
| | | sliding out of the ear |
| Otoscopy | Feedback paths characteristic of | Ear-canal/eardrum |
| | special ear canal/eardrum clinical | abnormalities, |
| | condition | undiagnosed condition |
| | Feedback paths characteristic of | Earwax in the ear canal |
| | earwax blocking the ear canal | |

The fault or condition indicated by the anomaly 305 is used to present an indication via a user interface device 306. The user interface device 306 may be an audio indicator (e.g., voice synthesized message via the receiver 307), indicator light, haptic signal, message on a smartphone application, etc. In the latter case, the user interface device 306 may be a communications interface (e.g., Bluetooth) that forms part of the user interface. In such a case, the smartphone or similar device acts as another part of the user interface.

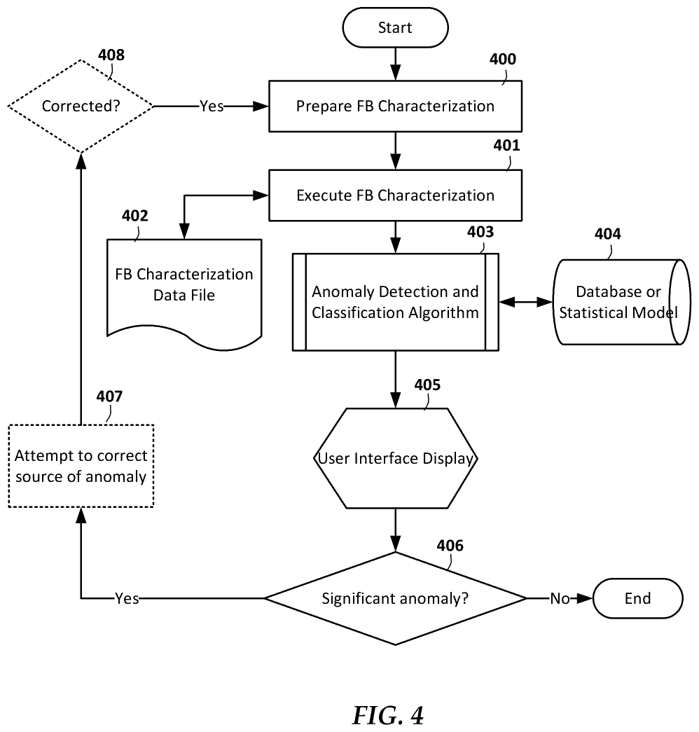

In FIG. 4, a flowchart shows a method according to an example embodiment. This method may be representative of a use case of a clinician initializing a feedback canceller during a fitting session with a patient. It will be understood that this may be repeated to re-characterize the feedback path transfer function to test for changes, faults, and the like during use. The method involves preparing 400 for the feedback characterization procedure, e.g., ensuring a proper fit of the hearing device, ensuring the hearing device settings are correct, preparing the user to expect noise played back in the headset, etc. The execution of the characterization begins at block 401, which uses a data file 402, e.g., an initialization file, which may provide data to the characterization program such as device parameters (e.g., model, version), test parameters (e.g., audio spectrum, duration), etc.

Block 403 represents the algorithm that detects and classifies anomalies as described in more detail elsewhere. The algorithm accesses a database and/or statistics model 404 in order to evaluate a currently measured feedback path transfer function to predetermined trend, pattern, behavior, etc. using an explicit algorithm and/or a machine learned model that makes the detection and classification based on being trained on data sets. The database and/or statistics model 404 may be formed as described in relation to FIG. 2.

The algorithm of block 403 determines an anomaly in the transfer function via comparison with example feedback path characterization data from database and/or statistics model 404. The algorithm predicts a fault associated with the hearing device based on the anomaly. An indication of the fault (or lack thereof) is presented via a user interface 405, e.g., a display. If the result of the algorithm is that a significant anomaly is detected or predicted (block 406 returns ‘yes’), the practitioner or user may be prompted with an indication of the prediction and may optionally try to solve the issue if possible, as indicated by block 407. If the anomaly is due to a correctable condition (e.g., earwax or other foreign matter blocking a port), then if an attempt is made to correct as indicated by block 408, the procedure can be repeated, e.g., starting again at block 400. Note that if blocks 407 and 408 are not used, control may still be passed from the ‘yes’ output of block 406 to block 400, e.g., to repeat and validate the original anomaly detection.

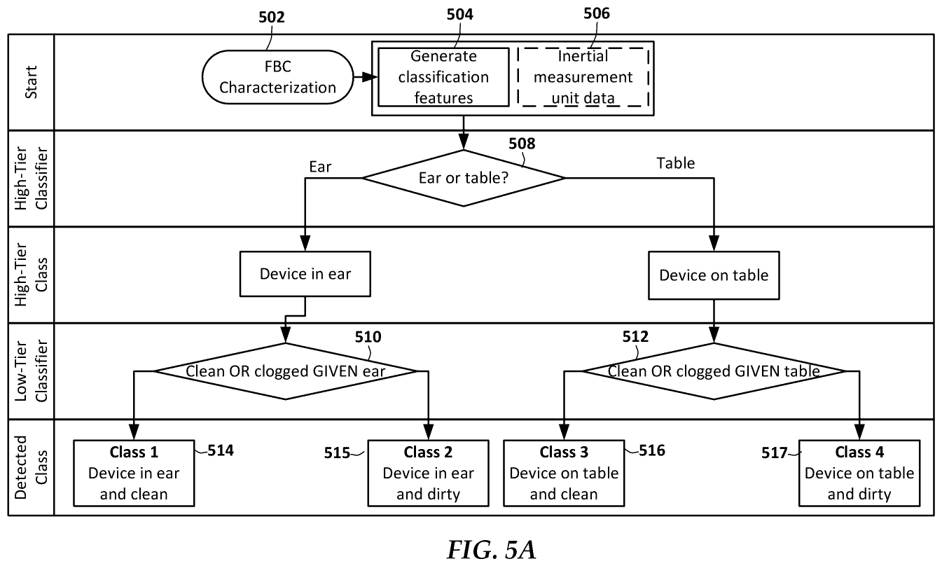

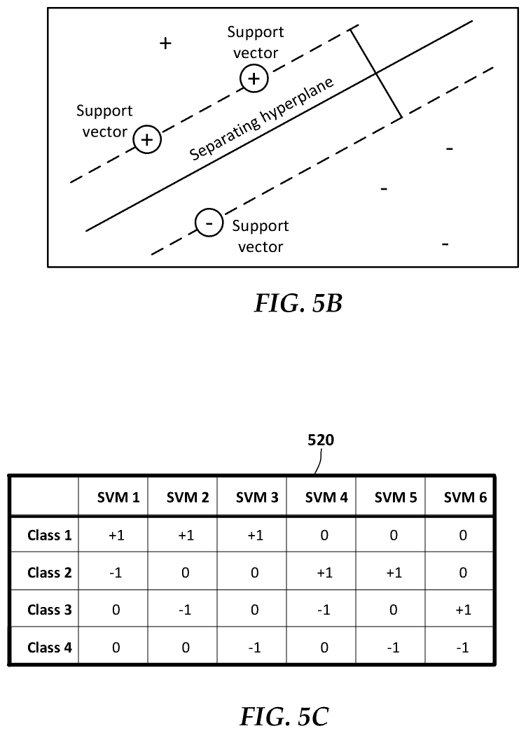

In FIG. 5A, a block diagram shows a decision tree for anomaly detection and classification according to an example embodiment. The algorithm may be integrated in fitting software for the feedback cancellation initialization/characterization. The initial input to the algorithm is the FBC characterization data 502, which includes both example feedback path characterization data and data (e.g., transfer function) gathered from the microphone. The classification features 504 are generated using the FBC characterization data 502. The classification features can be generated also using data 506 derived from output signals of an Inertial Measurement Unit (IMU).

A high-tier classifier 508 analyzes the features and determines whether the measurement has been done with the “device in the ear” or with the “device on the table.” In some embodiments the latter classification may include any out-of-ear condition, e.g., in charger, in pocket, etc. In some embodiments, the high tier classifier 508 could detect a third category (not shown), such as “otherwise” that flags the measurement as being done under anomalous/unknown/unreliable circumstances, and may not perform any second tier categorization as a result. The IMU data 506 can be used to detect movement (“device in the ear”) or the absence of it (“device on the table”). The IMU data 506 can also include an xyz-orientation of the device, e.g., horizontal xyz-orientation for “device on the table” and vertical xyz-orientation for “device in the ear.” The orientation measurements can rely on static IMU measurements (e.g., measurements that are relatively unchanging over time) for detecting in-ear use, unlike the motion detection method, which relies on dynamic IMU changes (e.g., measurements that are exhibit significant changes in magnitude and/or direction over time) to detect in-ear use. Using the motion detection and orientation detection together can increase the accuracy of the high-tier classifier 508.

Considering the “in ear” or “on table” classification from classifier 508, classifiers 510, 512 optimized for those specific measurement conditions are used to classify the present FBC characterization data as either “clean” or “dirty.” Finally, the detected classes 514-517 are a combination of the output of both high-tier and low-tier classifiers, e.g., class 515 would be “device in the ear and dirty”, whereas class 517 would be “device on the table and dirty.” Note that there may be more than four lower tier classes 514-517. In an example described below, there may be eight classes or more for each of the two high level classes, resulting in 16 or more total final classes. These lower tier classes can be used to judge states of multiple components simultaneously, such as microphones and receivers.

For example, when considering a device equipped with two outward-facing microphones and one receiver, the classification features extracted from the FBC characterization data consider the front feedback path B_{front}(Ωₖ), the rear feedback path Bᵣₑₐᵣ(Ωₖ) and a mathematical combination of both. This mathematical combination can be defined as shown in Equation (1)

$$F ( {Ω}_{k} ) = 20 \cdot {log}_{10} \vert \frac{{B}_{rear} ( {Ω}_{k} )}{{B}_{front} ( {Ω}_{k} )} \vert \qquad ( 1 )$$

Equation (1) denotes the magnitude frequency response of the relative transfer function (RTF) between the rear and front feedback paths relative to the receiver. If an inward-facing microphone is considered, there would be an equivalent feedback path to that microphone and two additional RTFs.

Non-mutually exclusive anomalies may be detected using parallel low-tier classifiers. For instance, distortion due to magnetization of the receiver (or microphone) is one low-tier classifier that may run in parallel to the ones exemplified above. A special measurement signal, for instance an exponential sine sweep, could be used to enable both anomalies to be detected simultaneously. In such embodiments, the FBC characterization data could be populated with example measurement sequences specially tailored for this and other issues.

When considering the measurement condition “device in the ear” and an inward-facing microphone, a first low-tier classifier may be used for assessing the health of the microphones and receiver, while additional low-tier classifiers may be used to assess the health of the patient's ears by considering possible cases of ear canal and eardrum pathologies. Hence, the additional low-tier classifier would detect pathologies that could have been overseen by the clinician during the otoscopy. As an alternative to device and otoscopic low-tier classifiers running in parallel, a two-step procedure may instead be used to increase the accuracy of the diagnostic algorithm by ensuring the integrity of the device first and checking the patient's ear canal and ear drum after the device has passed the test. Both of these steps can be considered a “self-test,” as they would both be measuring feedback paths, albeit looking for different results.

As shown in FIG. 5A, the decision tree cascades from a high-tier classifier 508 to low-tier classifiers 510, 512. The high-tier classifier 508 may be a two-class classifier implemented using a support-vector machine (SVM). The low-tier classifier 508 may be a multi-class classifier implemented using an error-correcting output code algorithm. The high-tier classifier 508 is trained aiming at discriminating between “ear” or “not-ear” for cases that might include clean and dirty devices. As noted above, the classifier 508 may also include an “otherwise” classification, e.g., if the classification is ambiguous and/or has a quality metric below some confidence threshold.

The block diagram of FIG. 5B is a geometric representation of an SVM implementation used to obtain a binary classifier. During training, the high-tier classifier searches for a hyperplane that separates the training data into two classes by margin maximization. The training data from both classes that are the closest to the hyperplane are the so-called support vectors. This may be structured such that, once the training is finished, the class “in-ear” will have positive distances and “not-in-ear” negative distances to the hyperplane.

The low-tier classifier for a particular high-tier class (such as “in-ear”) is trained considering examples measured in conditions that are both defined by the particular high-tier class together with all of the low-tier classes. For the “in-ear” case, clean and dirty devices are measured while worn in the ear. In some cases, classifiers may have more than two outputs. For example, a four output classifier may classify device states as all the permutations of one microphone and one receiver as dirty or clean. Classifiers with more than two outputs can be formed by combining the output of multiple two-class classifiers following the one-vs-one strategy, indicated by the combination matrix shown in the table 520 in FIG. 5C.

The example in table 520 has four output classes (e.g., one microphone and one receiver). These two-class classifiers can be implemented as support-vector machines, shown as SVM 1 to SVM 6 in the table 520. Each one of the two-class classifiers is an expert in discriminating one class from another specific one, while ignoring all the other classes. Hence there is a single positive “+1” and single negative “−1” class in each column and all the rest of the weights are “0.” In this approach one uses N₁ᵥₛ₁=C(C−1)/2 two-class classifiers, where C denotes the number of output classes.

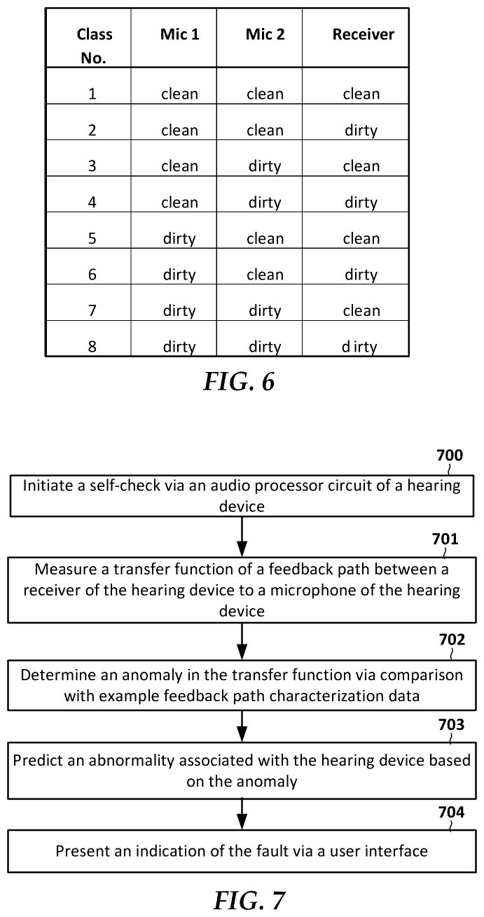

When considering a hearing device with two microphones and one receiver per device as described above, each one of them can be potentially clean or dirty. This results in C=8 output classes and will develop N=28 two-class classifiers. An example of the eight output classes is shown in the table of FIG. 6. An error-correction output code can combine the output of the two-class classifiers using the majority vote rule to infer the state of the device. In this voting scheme SVM 2 and 3 could be voting for Class 1, while SVM 1, 4 and could be voting for Class 2. The vote of SVM 6 is not relevant for Class 1 and Class 2. In this case Class 1 would get only two votes, while Class 2 would get three and, therefore Class 2 would be the output of the code. Note that the “−1” of SVM 1 for Class 2 is not to be understood as a negative vote, but just an indicator that for SVM 1, Class 2 is the so-called “negative class.” For instance, Class 1 in FIG. 6 means both microphones and receiver are clean, while Class 2 means that both microphones are clean and the receiver is dirty. Hence, in the latter would alert the user that the receiver needs to be cleaned.

In FIG. 7, a flowchart shows a method according to an example embodiment.

The method involves initiating 700 a self-check via an audio processor circuit of a hearing device. In response to the self-check, a transfer function of a feedback path is measured 701 between a receiver of the hearing device to a microphone of the hearing device and an anomaly in the transfer function is determined 702 (e.g., calculated, detected) via comparison with example feedback path characterization data, e.g., using a processor. An abnormality associated with the hearing device is predicted 703 based on the anomaly and an indication of the fault is presented 704 via a user interface of the hearing device.

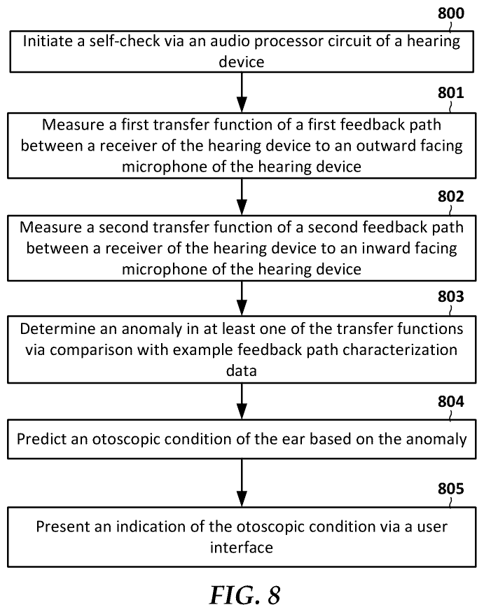

In FIG. 8, a flowchart shows a method according to an example embodiment.

The method involves initiating 800 a self-check via an audio processor circuit of a hearing device while in an ear of a user. In response to the self-check, a first transfer function of a first feedback path is measured 801 between a receiver of the hearing device to an outward facing microphone of the hearing device and a second transfer function of a second feedback path is measured 802 between a receiver of the hearing device to an inward facing microphone of the hearing device. An anomaly in at least one of the transfer functions is determined 803 (e.g., calculated, detected) via comparison with example feedback path characterization data, e.g., using a processor. An otoscopic condition is predicted 804 based on the anomaly and an indication of the otoscopic condition is presented 805 via a user interface of the hearing device. This presenting of the otoscopic condition may be an indicator that that a potential otoscopic anomaly has been detected (e.g., without providing a specific prognosis) and that the user may want to follow up with an appropriate professional (e.g., an ear, nose and throat specialist).

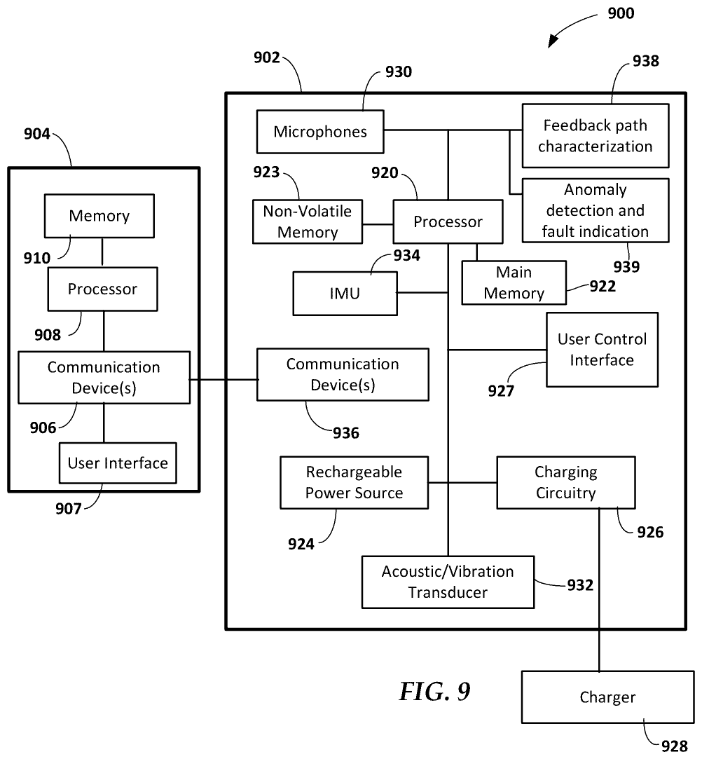

In FIG. 9, a block diagram illustrates a system and ear-worn hearing device 900 in accordance with any of the embodiments disclosed herein. The hearing device 900 includes a housing 902 configured to be worn in, on, or about an ear of a wearer. The hearing device 900 shown in FIG. 9 can represent a single hearing device configured for monaural or single-ear operation or one of a pair of hearing devices configured for binaural or dual-ear operation. The hearing device 900 shown in FIG. 9 includes a housing 902 within or on which various components are situated or supported. The housing 902 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 900 includes a processor 920 operatively coupled to a main memory 922 and a non-volatile memory 923. The processor 920 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 920 can include or be operatively coupled to main memory 922, such as RAM (e.g., DRAM, SRAM). The processor 920 can include or be operatively coupled to non-volatile (persistent) memory 923, such as ROM, EPROM, EEPROM or flash memory. As will be described in detail hereinbelow, the non-volatile memory 923 is configured to store instructions (e.g., module 938) that detect and mitigate vibrations for ANC subsystems.

The hearing device 900 includes an audio processing facility (also referred to as an audio processor circuit) operably coupled to, or incorporating, the processor 920. The audio processing facility includes audio signal processing circuitry (e.g., analog front-end, analog-to-digital converter, digital-to-analog converter, DSP, and various analog and digital filters), a microphone arrangement 930, and an acoustic/vibration transducer 932 (e.g., loudspeaker, receiver, bone conduction transducer, motor actuator). The microphone arrangement 930 can include one or more discrete microphones or a microphone array(s) (e.g., configured for microphone array beamforming). Each of the microphones of the microphone arrangement 930 can be situated at different locations of the housing 902. It is understood that the term microphone used herein can refer to a single microphone or multiple microphones unless specified otherwise.

At least one of the microphones 930 may be configured as a reference microphone producing a reference signal in response to external sound outside an ear canal of a user. Another of the microphones 930 may be configured as an error microphone producing an error signal in response to sound inside of the ear canal. The acoustic transducer 932 produces amplified sound inside of the ear canal.

The hearing device 900 may also include a user interface with a user control interface 927 operatively coupled to the processor 920. The user control interface 927 is configured to receive an input from the wearer of the hearing device 900. The input from the wearer can be any type of user input, such as a touch input, a gesture input, or a voice input. The user control interface 927 may be configured to receive an input from the wearer of the hearing device 900.

The hearing device 900 also includes a feedback path characterization module 938 operably coupled to the processor 920. The module 938 can be implemented in software, hardware (e.g., specialized neural network logic circuitry, general purpose processor), or a combination of hardware and software. During operation of the hearing device 900, the module 938 can be used to perform self-tests that include send a signal (e.g., one or more tones, wideband noise) through the acoustic transducer 932 and sensing a response at one or more microphones 930. The response includes (or is used to calculate or derive) a transfer function of one or more feedback paths. The module 938 may be integrated with a feedback cancelling module (not shown) or implemented separately. An anomaly detection and fault indication module 939 uses the measured feedback path response to determining deviations that are indicative of hardware faults, misconfiguration of the device, and/or otoscopic conditions.

The anomaly detection and fault indication module 939 operates with the feedback path characterization module 938 to receive the derived transfer function and determine an anomaly in the transfer function via comparison with example feedback path characterization data. The anomaly is predictive of one or more faults associated with the hearing device, and an indication of at least one of the predicted faults is presented to the user and/or a practitioner via the user interface 927. The anomaly detection and fault indication module 939 may interact with an IMU 934 to determine an operating context of the hearing device 900, e.g., in-ear, out-of-ear, etc., which can affect how the feedback path measurement is analyzed.

The hearing device 900 can include one or more communication devices 936. For example, the one or more communication devices 936 can include one or more radios coupled to one or more antenna arrangements that conform to an IEEE 902.9 (e.g., Wi-Fi®) or Bluetooth® (e.g., BLE, Bluetooth® 4.2, 5.0, 5.1, 5.2 or later) specification, for example. In addition, or alternatively, the hearing device 900 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 936 may also include wired communications, e.g., universal serial bus (USB) and the like.

The communication device 936 is operable to allow the hearing device 900 to communicate with an external computing device 904, e.g., a mobile device such as smartphone, laptop computer, etc. The external computing device 904 may also include a device usable by a clinician in a clinical setting, such as a desktop computer, test apparatus, etc. The external computing device 904 includes a communications device 906 that is compatible with the communications device 936 for point-to-point or network communications. The external computing device 904 includes its own processor 908 and memory 910, the latter which may encompass both volatile and non-volatile memory. A user interface 907 facilitates interactions between the external computing device 904 and the hearing device 900, including indications of faults or other conditions from module 939. The external computing device 904 may perform some functions described herein associated with the audio processor circuit, such as determining an anomaly in a transfer function, predicting a fault, etc.

The hearing device 900 also includes a power source, which can be a conventional battery, a rechargeable battery (e.g., a lithium-ion battery), or a power source comprising a supercapacitor. In the embodiment shown in FIG. 9, the hearing device 900 includes a rechargeable power source 924 which is operably coupled to power management circuitry for supplying power to various components of the hearing device 900. The rechargeable power source 924 is coupled to charging circuitry 926. The charging circuitry 926 is electrically coupled to charging contacts on the housing 902 which are configured to electrically couple to corresponding charging contacts of a charger 928 when the hearing device 900 is placed in the charger. Status of the charging circuitry 926 (e.g., device in charger) may be communicated to the anomaly detection and fault indication module 939 to assist in determining a context of the device 900, e.g., indicative of an expected feedback path within a charger as opposed to an in-ear or other feedback path.

As noted above, in addition to determining device abnormalities, a feedback path measuring system may be used to predict otoscopic conditions. Otoscopic conditions may affect geometry of ear tissue structures due to changes in the tissue (e.g., swelling) or buildup of foreign matter (e.g., earwax). Otoscopic conditions may cause other physical changes, such as changes in tissue density, moisture, material composition (e.g., buildup of hard deposits, bodily fluids), all of which may affect the feedback path. While some clinicians can diagnose these conditions, sometimes and so the feedback path measurements may provide a double check in situations where the conditions are overlooked.

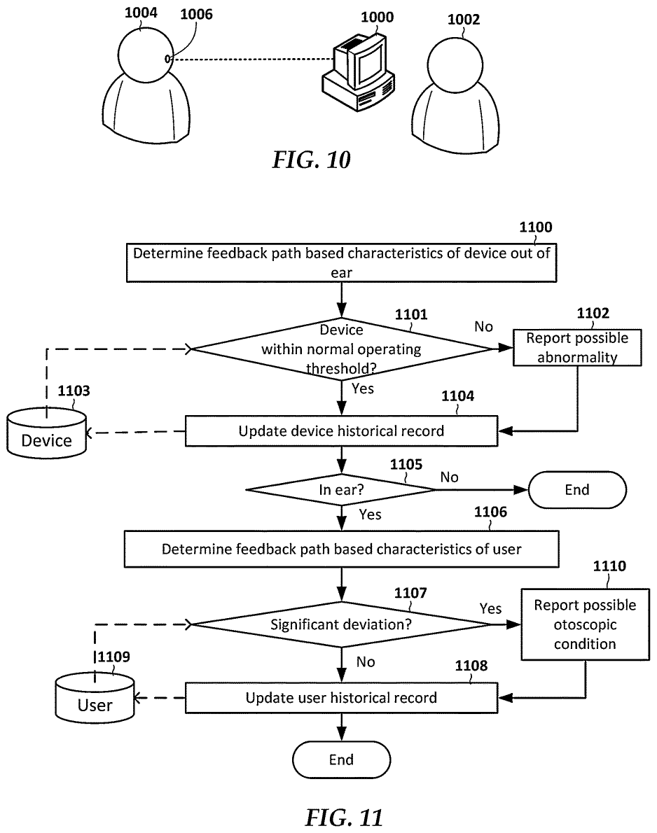

Therefore, in some embodiments, the capability to detect device abnormalities through feedback path measurement can also be used to detect otoscopic conditions. In FIG. 10, a block diagram illustrates a system according to an example embodiment. The system includes a test apparatus 1000 that is used by a clinician 1002 to detect otoscopic anomalies of a patient 1004 via a hearing device 1006. Generally, the apparatus 1000 may include computing hardware as described in FIG. 9, e.g., the external device 904. The apparatus 1000 may run an advanced diagnostic routine (e.g., software instructions) that can obtain feedback path measurements from the hearing device 1006 while being worn by the patient 1004, and compare the response to a large population of corresponding otoscopic measurements, e.g., by accessing a database via a network. This may be able to catch some issues that might not be readily visible by inspection or may not have been a source of complaint for the patient (e.g., no discomfort reported).

The process shown in FIG. 10 can also be implemented without the involvement of a clinician, e.g., as an at-home diagnostic. A user's own device such as a computer or mobile phone could be used in place of the test apparatus 1000. The user interface could be simplified based on the assumption that the user is unfamiliar with medical or otoscopic terminology, although an online database may similarly be accessed for comparison. The predictions could be tailored to be more advisory and less technical, e.g., suggest mentioning results during the next checkup. A more detailed analysis could be communicated to a clinician via the user device, e.g., via a medical portal.

Once the hearing device 1006 is set up, it can gather historical data that can detect changes in the ear and surrounding tissue on the head. This can provide a user with long-term monitoring of conditions proximate the ear. In FIG. 11, a flowchart shows a method for otoscopic monitoring according to an example embodiment. The method can be triggered repeatedly, e.g., as a background process. A first self-check is represented by blocks 1100-1104. At block 1100, a feedback path test as described above can be performed outside the ear, e.g., in a charger. Performing the test outside the ear can help isolate device anomalies from otoscopic anomalies.

As with previous embodiments, if the device is outside an operating threshold as determined at block 1101, an indication is provided at block 1102 that a device abnormality is detected. Otherwise a database 1103 is updated at block 1104 in order to provide long-term tracking of device performance, e.g., to adjust operational thresholds, detect slow deterioration of components, etc. Thus this data can be referenced during the determination made at block 1101. Note that the lines leading into and out of the databases 1103, 1109 are dashed to indicate data storage and retrieval, in contrast to control flow indicated by solid lines. Also note that a detected device anomaly can be added to the database 1103, e.g., for logging purposes, after being reported at block 1102.

Once the device is confirmed to be nominally operational, block 1105 will trigger a second self-check, which includes an otoscopic test during a time when the device is detected in the ear (or on the head as appropriate). A manually-triggered or automatically triggered test at block 1106 determines an in ear feedback path characteristic, which is used to determine any significant deviations from a historical performance at block 1107. If a deviation is detected, this is reported at block 1110, and the measurements are used to update a user otoscopic database 1109 at block 1108. The criterion for triggering reporting at block 1110 may be different than for device anomalies, as it may be preferable to reduce false positives for otoscopic-related predictions. For example, the detected deviation or anomaly may be tracked over time to ensure it is persistent and/or follows a trend before reporting as a predicted abnormal otoscopic condition.

This document discloses numerous example embodiments, including but not limited to the following:
Example A1 is method implemented via one or more processors of a hearing device. The method comprises initiating a self-check via an audio processing circuit of the hearing device while located in an ear of a user; measuring a first transfer function of a first feedback path between a receiver of the hearing device and at least one outward facing microphone of the hearing device; measuring a second transfer function of a second feedback path between the receiver and an inward facing microphone of the hearing device; determining, via a sound processor circuit, an anomaly in at least one of the first transfer function and the second transfer function; predicting an otoscopic condition of the ear based on the anomaly; and presenting an indication of the otoscopic condition via a user interface circuit. Example A2 includes the method of example A1, wherein the self-check is initialized by a clinician during a fitting of the hearing device. Example A3 includes the method of example A1, wherein the self-check is initialized by an input from the user into a personal mobile device, and wherein the mobile device comprises the user interface device.
Example A4 includes the method of any previous method example, further comprising: determining an orientation measurement of the hearing device from an inertial measurement unit of the hearing device; and detecting that the hearing device is in an ear of the user based on the orientation measurement, wherein the determining of the first and second transfer function occurs when the hearing device is detected in the ear. Example A5 includes the method of example A4, further comprising detecting a movement of the hearing device from the inertial measurement unit, wherein the determining that the hearing device is in the ear of the user is based on both the orientation measurement and the detected movement.
Example A6 includes the method of any previous method example, wherein the at least one outward facing microphone comprises a front microphone and rear microphone, the first feedback path method further comprising calculating a relative transfer function as a combination of front and rear feedback paths of the respective front and rear microphones, a magnitude frequency response of the relative transfer function used in determining the first transfer function. Example A7 includes the method of any previous method example, wherein the at least outward facing microphone comprises a front microphone and rear microphone, the first transfer function of the first feedback path measured with the front microphone, the method further comprising measuring a third transfer function of a third feedback path between the receiver to at the rear microphone, and wherein the anomaly is determined based on any combination of the first, second and third transfer functions.
Example A8 includes the method of any previous method example, further comprising, before determining the anomaly in at least one of the first transfer function and the second transfer function, performing a diagnostic of the hearing device based on device diagnostic measurements of one or both of the first and second feedback paths. Example A9 includes the method of example A8, wherein the diagnostic is performed with the hearing device outside of the user's ear. Example A10 includes the method of any previous method example, wherein the self-check comprises a feedback canceller self-check. Example A11 includes the method of any previous method example, wherein the self-check is initiated automatically in the background by the hearing device.
Example B12 is hearing device, comprising: at least one outward facing microphone and an inward facing microphone; a receiver; a user interface circuit; and a sound processor coupled to the at least one microphone, the receiver, and the user interface circuit, the sound processor configured via instructions to perform: initiating a self-check; in response to the self-check, measuring a first transfer function of a first feedback path between the receiver and the at least one outward facing microphone; measuring a second transfer function of a second feedback path between the receiver and the inward facing microphone; determining an anomaly in at least one of the first transfer function and the second transfer function; predicting an otoscopic condition of an ear based on the anomaly; and presenting an indication of the otoscopic condition via the user interface circuit.
Example B13 includes the hearing device of example B12, wherein the self-check is initialized by a clinician during a fitting of the hearing device. Example B14 includes the hearing device of example B12, wherein the self-check is initialized by an input from the user into a personal mobile device, and wherein the mobile device comprises the user interface device. Example B15 includes the hearing device of any previous hearing device example, further comprising an inertial measurement unit, and wherein the sound processor further performs: determining an orientation measurement of the hearing device from the inertial measurement unit; and determining that the hearing device is in an ear of the user based on the orientation measurement, wherein the determining of the first and second transfer function occurs when the hearing device is detected in the ear. Example B16 includes the hearing device of example B15, wherein the sound processor further performs detecting a movement of the hearing device from the inertial measurement unit, wherein the determining that the hearing device is in the ear of the user is based on both the orientation measurement and the detected movement.
Example B17 includes the hearing device of any previous hearing device example, wherein the at least one outward facing microphone comprises a front microphone and rear microphone, the first feedback path comprising a combination of front and rear feedback paths of the respective front and rear microphones. Example B18 includes the hearing device of any previous hearing device example, wherein the at least outward facing microphone comprises a front microphone and rear microphone, the first transfer function of the first feedback path measured with the front microphone, the sound processor further measuring a third transfer function of a third feedback path between the receiver to at the rear microphone, and wherein the anomaly is determined based on any combination of the first, second and third transfer functions.
Example B19 includes the hearing device of any previous hearing device example, further comprising, before determining the anomaly in at least one of the first transfer function and the second transfer function, performing a diagnostic of the hearing device based on device diagnostic measurements of one or both of the first and second feedback paths. Example B20 includes the hearing device of example B19, wherein the diagnostic is performed with the hearing device outside of the user's ear. Example B21 includes the hearing device of any previous hearing device example, wherein the self-check comprises a feedback canceller self-check. Example B22 includes the hearing device of any previous hearing device example, wherein the self-check is initiated automatically in the background by the hearing device.
Example B23 is a system comprising the hearing device of example B12, the system further comprising an apparatus coupled to the hearing device, the apparatus comprising one or more processors and computer instructions operable to determine the anomaly in at least one of the first transfer function and the second transfer function.
Example B24 includes the system of example B23, wherein the computer instructions access a database comprising a population of corresponding otoscopic measurements, the at least one of the first transfer function and the second transfer function being compared to the corresponding otoscopic measurements.
Example C25 is method implemented via one or more processors of a hearing device, comprising: initiating a first self-check via an audio processing circuit of the hearing device while located in outside the ear of a user, the first self-check comprising measuring a first transfer function of a first feedback path between a receiver of the hearing device and at least one microphone of the hearing device; based on the first transfer function indicating that the hearing device is operating normally, initiating a second self-check via the audio processing circuit while located in inside the ear, the second self-check comprising: measuring a second transfer function of a second feedback path between the receiver and the at least one microphone; determining, via a sound processor circuit, an anomaly in the second transfer function; predicting an otoscopic condition of the ear based on the anomaly; and presenting an indication of the otoscopic condition via a user interface circuit.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A method implemented via one or more processors of a hearing device, comprising:
initiating a self-check via an audio processing circuit of the hearing device while located in an ear of a user;
measuring a first transfer function of a first feedback path between a receiver of the hearing device and at least one outward facing microphone of the hearing device;
measuring a second transfer function of a second feedback path between the receiver and an inward facing microphone of the hearing device;
determining, via a sound processor circuit, an anomaly in at least one of the first transfer function and the second transfer function;
predicting an otoscopic condition of the ear based on the anomaly; and
presenting an indication of the otoscopic condition via a user interface circuit.

2. The method of claim 1, wherein the self-check is initialized by a clinician during a fitting of the hearing device.

3. The method of claim 1, wherein the self-check is initialized by an input from the user into a personal mobile device, and wherein the mobile device comprises the user interface device.

4. The method of claim 1, further comprising:
determining an orientation measurement of the hearing device from an inertial measurement unit of the hearing device; and
detecting that the hearing device is in an ear of the user based on the orientation measurement, wherein the determining of the first and second transfer function occurs when the hearing device is detected in the ear.

5. The method of claim 4, further comprising detecting a movement of the hearing device from the inertial measurement unit, wherein the determining that the hearing device is in the ear of the user is based on both the orientation measurement and the detected movement.

6. The method of claim 1, wherein the at least one outward facing microphone comprises a front microphone and rear microphone, the method further comprising calculating a relative transfer function as a combination of front and rear feedback paths of the respective front and rear microphones, wherein the anomaly is determined based on a combination of a magnitude frequency response of the relative transfer function, the first transfer function, and the second transfer function.

7. The method of claim 1, wherein the at least outward facing microphone comprises a front microphone and rear microphone, the first transfer function of the first feedback path measured with the front microphone, the method further comprising measuring a third transfer function of a third feedback path between the receiver to at the rear microphone, and wherein the anomaly is determined based on any combination of the first, second and third transfer functions.

8. The method of claim 1, further comprising, before determining the anomaly in at least one of the first transfer function and the second transfer function, performing a diagnostic of the hearing device based on device diagnostic measurements of one or both of the first and second feedback paths.

9. The method of claim 8, wherein the diagnostic is performed with the hearing device outside of the user's ear.

10. The method of claim 1, wherein the self-check comprises a feedback canceller self-check.

11. The method of claim 1, wherein the self-check is initiated automatically in the background by the hearing device.

12. A hearing device, comprising:
at least one outward facing microphone and an inward facing microphone;
a receiver;
a user interface circuit; and
a sound processor coupled to the at least one microphone, the receiver, and the user interface circuit, the sound processor configured via instructions to perform:
initiating a self-check;
in response to the self-check, measuring a first transfer function of a first feedback path between the receiver and the at least one outward facing microphone;
measuring a second transfer function of a second feedback path between the receiver and the inward facing microphone;
determining an anomaly in at least one of the first transfer function and the second transfer function;
predicting an otoscopic condition of an ear based on the anomaly; and
presenting an indication of the otoscopic condition via the user interface circuit.

13. The hearing device of claim 12, wherein the self-check is initialized by a clinician during a fitting of the hearing device.

14. The hearing device of claim 12, wherein the self-check is initialized by an input from the user into a personal mobile device, and wherein the mobile device comprises the user interface device.

15. The hearing device of claim 12, further comprising an inertial measurement unit, and wherein the sound processor further performs:
determining an orientation measurement of the hearing device from the inertial measurement unit; and
determining that the hearing device is in an ear of the user based on the orientation measurement, wherein the determining of the first and second transfer function occurs when the hearing device is detected in the ear.

16. The hearing device of claim 15, wherein the sound processor further performs detecting a movement of the hearing device from the inertial measurement unit, wherein the determining that the hearing device is in the ear of the user is based on both the orientation measurement and the detected movement.

17. The hearing device of claim 12, wherein the at least one outward facing microphone comprises a front microphone and rear microphone, the first feedback path comprising a combination of front and rear feedback paths of the respective front and rear microphones.

18. The hearing device of claim 12, wherein the at least outward facing microphone comprises a front microphone and rear microphone, the first transfer function of the first feedback path measured with the front microphone, the sound processor further measuring a third transfer function of a third feedback path between the receiver to at the rear microphone, and wherein the anomaly is determined based on any combination of the first, second and third transfer functions.

19. The hearing device of claim 12, further comprising, before determining the anomaly in at least one of the first transfer function and the second transfer function, performing a diagnostic of the hearing device based on device diagnostic measurements of one or both of the first and second feedback paths.

20. A method implemented via one or more processors of a hearing device, comprising:
initiating a first self-check via an audio processing circuit of the hearing device while located outside the ear of a user, the first self-check comprising measuring a first transfer function of a first feedback path between a receiver of the hearing device and at least one microphone of the hearing device;
based on the first transfer function indicating that the hearing device is operating normally, initiating a second self-check via the audio processing circuit while located in inside the ear, the second self-check comprising:
measuring a second transfer function of a second feedback path between the receiver and the at least one microphone;
determining, via a sound processor circuit, an anomaly in the second transfer function;
predicting an otoscopic condition of the ear based on the anomaly; and
presenting an indication of the otoscopic condition via a user interface circuit.
